(19) United States
(12) Patent Application Publication
(10) Pub. No.: US 2011/0234651 A1
(43) Pub. Date: Sep. 29, 2011

(54) SCREEN SWITCHING METHOD AND ELECTRONIC APPARATUS USING THE SAME

(75) Inventors: Yang-Peng Chen, New Taipei City (TW); Hung-Yang Hsu, New Taipei City (TW); Yung-An Fang, New Taipei City (TW)

(73) Assignee: Wistron Corporation, New Taipei City (TW)

(21) Appl. No.: 13/053,571

(22) Filed: Mar. 22, 2011

(30) Foreign Application Priority Data
Mar. 23, 2010 (TW) 099108498

(51) Int. Cl. G09G 5/10

(52) U.S. Cl. 345/690

(57) ABSTRACT

A screen switching method for an electronic apparatus includes an e-Paper and a display having a backlight module. The e-Paper and the display are used to show an image signal. The screen switching method includes determining whether a brightness value at which the backlight module is set exceeds a threshold value, controlling the display to show the image signal if the brightness value of the backlight module exceeds the threshold value, and controlling the e-Paper to show the image signal if the brightness value of the backlight module does not exceed the threshold value. An electronic apparatus implementing the screen switching method is also disclosed.

### CROSS-REFERENCE TO RELATED APPLICATION

This application claims priority of Taiwanese Application No. 099108498, filed on Mar. 23, 2010.

### BACKGROUND OF THE INVENTION

1. Field of the Invention

The present invention relates to a screen switching method and an electronic apparatus, more particularly to a screen switching method and an electronic apparatus using the same, in which screen switching is performed according to the light brightness of a backlight module.

2. Description of the Related Art

With the digitalization of books by the publishing industry, more and more electronic publications will be available in the future, such that e-Paper (electronic paper) applications will become increasingly important. Using ambient light as a light source, e-Paper does not require its own light source, and so it keeps in line with current trends related to environmental protection and energy conservation. In addition, with the use of e-Paper, a user does not need to stare at a display with its own light source for a long time, thereby providing a more comfortable reading environment.

However, e-Paper under insufficient ambient light may not be read easily, and so a commercial electronic apparatus combining e-Paper and an LCD (liquid crystal display) has been promoted. Accordingly, a user can choose either the e-Paper or the LCD as a display screen. However, using the LCD as a display screen consumes more electricity.

Therefore, if the backlight module of the LCD could be the light source for the e-Paper in a dark environment, then it would be unnecessary to use the LCD as the display screen in a dark environment, and energy savings could be achieved.

### SUMMARY OF THE INVENTION

Therefore, the object of the present invention is to provide a screen switching method, which can be applied to an electronic apparatus having two display screens.

According to one aspect, the screen switching method of this invention is used in an electronic apparatus including an e-Paper and a display having a backlight module. The e-Paper and the display are used to show an image signal. The screen switching method comprises: a) determining whether a brightness value at which the backlight module is set exceeds a threshold value; b) controlling the display to show the image signal if the brightness value of the backlight module exceeds the threshold value; and c) controlling the e-Paper to show the image signal if the brightness value of the backlight module does not exceed the threshold value.

In some embodiments, when the electronic apparatus shows the image signal using the e-Paper, and in step a), the brightness value exceeds the threshold value, the screen switching method further comprises between step a) and step b) storing the image signal in a memory of the electronic apparatus; wherein in step b), the image signal is read from the memory and transmitted to the display.

In some embodiments, in step b), the e-Paper is switched off when the display shows the image signal.

In some embodiments, when the electronic apparatus shows the image signal using the display, and in step a), the brightness value does not exceed the threshold value, the screen switching method further comprises between step a) and step c): storing the image signal in a memory of the electronic apparatus; wherein in step b), the image signal is read from the memory and transmitted to the e-Paper.

In some embodiments, in step c), the display is switched off when the e-Paper shows the image signal.

In some embodiments, the brightness value is set by a UI (user interface) of the electronic apparatus.

In some embodiments, the brightness value is set by a light sensor of the electronic apparatus sensing ambient light brightness.

In some embodiments, the brightness value can be set by a UI of the electronic apparatus overriding the setting by the light sensor.

In some embodiments, in step c), the backlight module can function as the light source for the e-Paper.

According to another aspect, the electronic apparatus for showing an image signal of the present invention comprises: an e-Paper; a display including a display panel and a backlight module for providing a light source to the display panel; a brightness adjustment module for setting a brightness value of the backlight module; a control module for selecting either to send the image signal to the display or to the e-Paper; and a determining module for determining whether the brightness value exceeds a threshold value, where the determining module controls the control module to send the image signal to the display for showing thereon if the brightness value exceeds the threshold value, and the determining module controls the control module to send the image signal to the e-Paper for showing thereon if the brightness value does not exceed the threshold value.

In some embodiments, the control module includes a memory for storing the image signal, when the electronic apparatus shows the image signal via the e-Paper and the determining module determines that the brightness value exceeds the threshold value, the determining module controls the control module to temporarily store the image signal in the memory, after which the image signal is read from the memory and sent to the display for showing thereon.

In some embodiments, the control module switches off the e-Paper.

In some embodiments, the control module further includes a memory for storing the image signal, when the electronic apparatus shows the image signal via the display and the determining module determines that the brightness value does not exceed the threshold value, the determining module controls the control module to temporarily store the image signal in the memory, after which the image signal is read from the memory and sent to the e-Paper for showing thereon.

In some embodiments, the control module switches off the display.

In some embodiments, the display is a transparent LCD, one surface of the display being connected to the e-Paper, and the other surface of the display facing a user.

In some embodiments, the backlight module is disposed on a side of the display panel, the electronic apparatus further comprising a light guide plate disposed between the e-Paper and the display, the light guide plate being used to direct light from the backlight module above the e-Paper.

In some embodiments, the electronic apparatus further comprises a UI (user interface) connected to the brightness adjustment module, the brightness adjustment module being used for setting the brightness value in accordance with a first brightness adjustment signal from the UI.

In some embodiments, the electronic apparatus further comprises a light sensor that is connected to the brightness adjustment module and is used for sensing ambient light brightness, the brightness adjustment module setting the brightness value in accordance with a second brightness adjustment signal from the light sensor, the second brightness adjustment signal including information of the ambient light brightness.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart of the preferred embodiment of a screen switching method of the present invention;

FIG. 2 is a schematic appearance of an electronic apparatus according to the preferred embodiment of the present invention;

FIG. 3 is a schematic view, illustrating positional relationships among e-Paper, an LCD, and a light guide plate of the electronic apparatus of the preferred embodiment; and

FIG. 4 is a schematic circuit block diagram of the preferred embodiment to illustrate connections among components of the electronic apparatus.

### DETAILED DESCRIPTION OP THE PREFERRED-EMBODIMENT

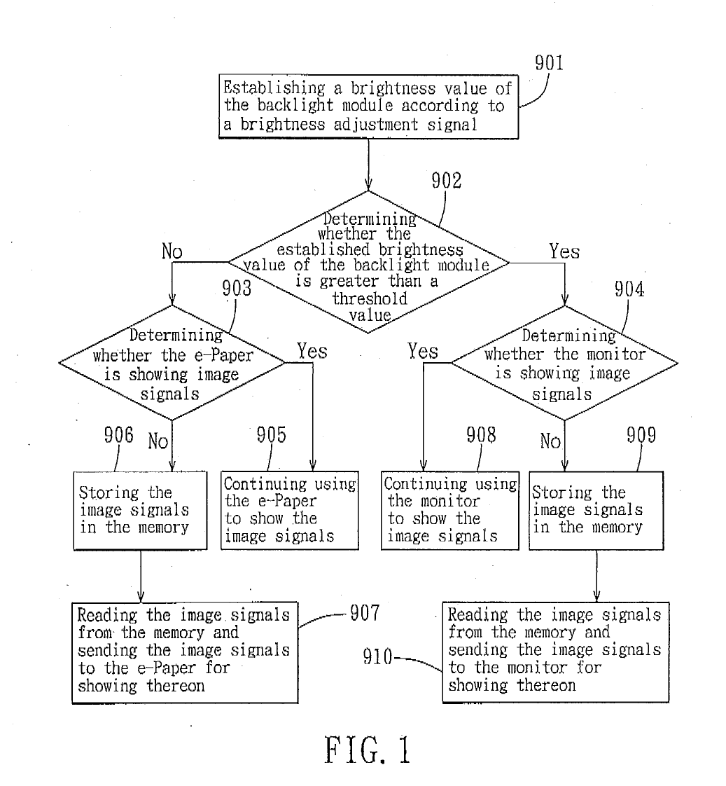

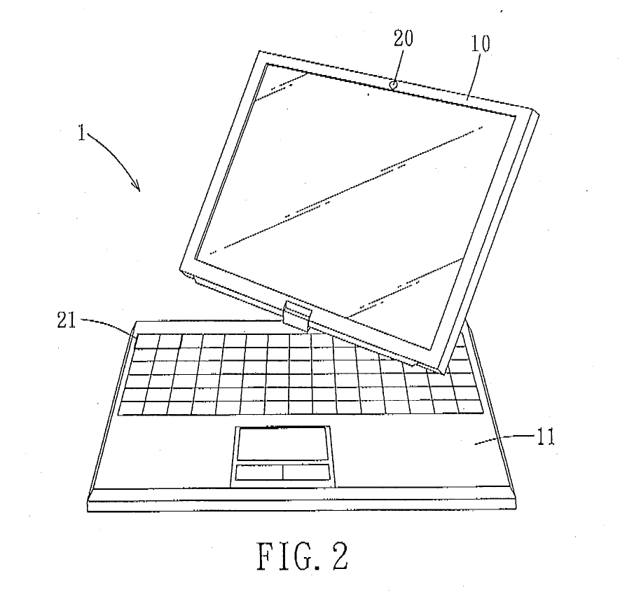

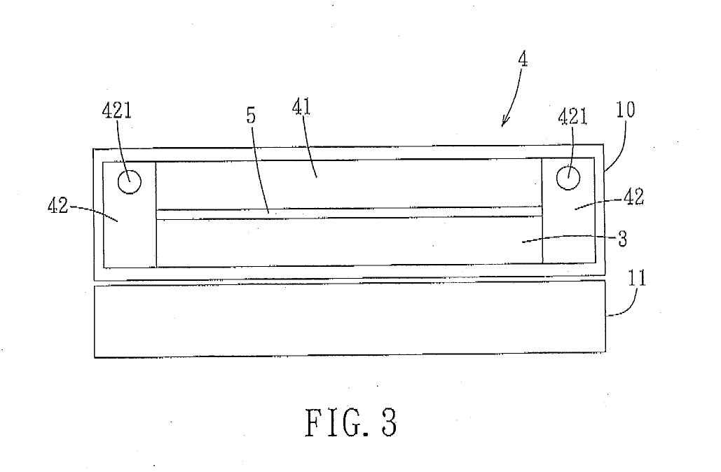

Referring to FIGS. 1 and 2, a preferred embodiment of a screen switching method according to the present invention is applied to an electronic apparatus 1 with a switchable screen. In this embodiment, the electronic apparatus 1 is a notebook computer, but is not limited thereto. Referring to FIG. 2, the electronic apparatus 1 includes an apparatus body 11, and a cover body 10 that is coupled pivotally to the apparatus body 11 and is able to be opened, closed, and rotated relative to the apparatus body 11. As shown in FIG. 3, the cover body 10 includes a first surface and a second surface, which are provided respectively with an e-Paper 3 and an LCD 4 connected electrically to the apparatus body 11. When the cover body 10 is opened, it can be rotated leftward and rightward relative to the apparatus body 11, such that a user can choose either the e-Paper 3 or the LCD 4 as the display screen. When the electronic apparatus 1 is used in a tablet mode, the cover body 10 covers the apparatus body 11 with the e-Paper 3 facing toward the apparatus body 11, as shown in FIG. 3. That is, the apparatus body 11, the e-Paper 3 and the LCD 4 are stacked in this order with the apparatus body 11 being at the bottom of the stack. In this embodiment, the LCD 4 is a transparent LCD.

Referring to FIG. 3, the LCD 4 includes an LCD panel 41 and a backlight module 42. The LCD panel 41 is stacked on the e-Paper 3. The backlight module 42 includes two light-emitting components 421, which are disposed respectively on two sides of the LCD panel 41 and are used as a light source for the LCD panel 41. In this embodiment, each of the light-emitting components 421 includes an LED (light-emitting diode) module, but is not limited thereto. For instance, each of the light-emitting components 421 may include a CCFL (cold cathode fluorescent lamp). It is to be noted that the electronic apparatus 1 further includes a light guide plate 5 disposed between the e-Paper 3 and the LCD 4 in order to allow use of the light-emitting components 421 of the backlight module 42 as a light source for the e-Paper 3. As a result, part of the light emitted from the light-emitting components 421 can be directed between the LCD 4 and the e-Paper 3 by the light guide plate 5, such that the light-emitting components 421 of the backlight module 42 can be the light source for the e-Paper 3 under insufficient ambient light.

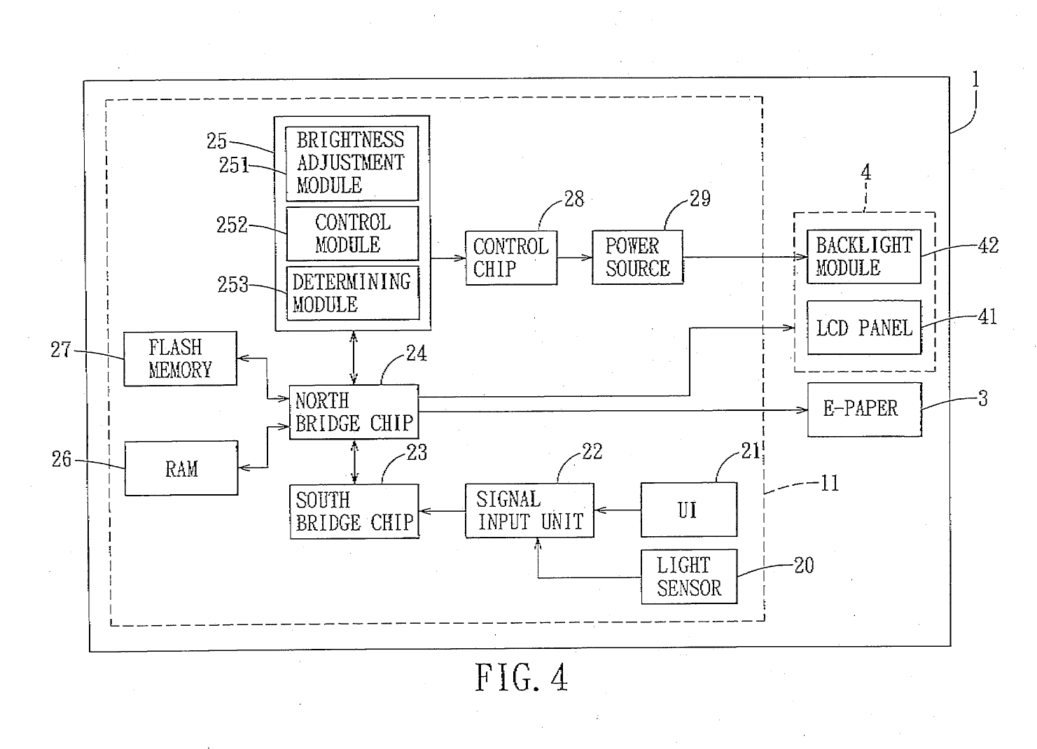

Referring to FIG. 4, the apparatus body 11 includes a UI (user interface) 21, a signal input unit 22 that is connected electrically to the UI 21, a south bridge chip 23 that is connected electrically to the signal input unit 22, a north bridge chip 24 that is connected electrically to the south bridge chip 23, the LCD 4, and the e-Paper 3, a CPU (central processing unit) 25 that is connected electrically to the north bridge chip 24, a RAM (random access memory) 26 that is connected electrically to the north bridge chip 24, a flash memory 27 that is connected electrically to the north bridge chip 24, a control chip 28 that is connected electrically to the CPU 25, and a power source 29 that is connected electrically to the control chip 28. The operations of the signal input unit 22, the south bridge chip 23, the north bridge chip 24, and the RAM 26 are common in the prior art so a further description thereof will not be provided herein. The flash memory 27 is used for storing image signals that are waiting to be shown. In this embodiment, the apparatus body 11 is installed with a first operating system (OS) for use when the LCD 4 is being used as the display screen and with a second operating system for use when the e-Paper 3 is being used as the display screen. In other words, when the electronic apparatus 1 selects the LCD 4 to show image signals, the first operating system is used to perform processing. On the other hand, when the electronic apparatus 1 selects the e-Paper 3 to show image signals, the second operating system is used to perform processing. The first operating system (for example, the Linux OS) is the main operating system for the electronic apparatus 1, and is required to communicate with all hardware and peripheral devices. As a result, the first operating system has a longer start-up time. The second operating system (for example, an e-Paper OS) mainly governs display operations for the e-Paper 3, and does not manage the communication with other hardware and peripheral devices of the electronic apparatus 1. Hence, the second operating system has a shorter start-up time. Hardware inside the apparatus body 11 and the peripheral devices share these two operating systems.

As shown in FIG. 2, the UI 21 is a keypad module disposed on the apparatus body 11, which can be operated by a user to produce a first brightness adjustment signal and transmit the same to the CPU 25 via the signal input unit 22, the south bridge chip 23, and the north bridge chip 24, such that the CPU 25 adjusts the brightness of the display screen of the electronic apparatus 1 (i.e., brightness of the backlight module 42 is adjusted). The CPU 25 includes a brightness adjustment module 251, a control module 252, and a determining module 253. The brightness adjustment module 251 is used for setting a brightness value of the backlight module 42. The control module 252 is used for selecting to send image signals to either the LCD 4 or the e-Paper 3 for showing thereon. The determining module 253 is used for determining whether the brightness value exceeds a threshold value. If it does, then the determining module 253 sends the image signals to the LCD 4 for showing thereon. If the brightness value does not exceed the threshold value, then the determining module 253 sends the image signals to the e-Paper 3 for showing thereon. It is to be noted that the brightness adjustment module 251, the control module 252, and the determining module 253 are implemented by software programs that drive hardware.

Referring to FIGS. 1 and 4, in step 901, the UI 21 generates the first brightness adjustment signal upon activation by the user, and the first brightness signal is then transmitted to the brightness adjustment module 251 of the CPU 25 via the signal input unit 22, the south bridge chip 2, and the north bridge chip 24. According to the first brightness adjustment signal, the brightness adjustment module 251 establishes a brightness value of the backlight module 42. Next, according to the established brightness value, the control chip 20 controls the power source 29 to thereby vary a voltage provided to the backlight module 42 by the power source 29 so as to adjust the brightness of the backlight module 42.

Next, in step 902, the determining module 253 determines whether the established brightness value of the backlight module 42 is greater than a threshold value. In this embodiment, the brightness value can be classified from level 1 to level 10. Level 1 represents the situation in which the backlight module 42 has a minimal brightness value or does not emit light. Level 10 represents the maximal brightness value of the backlight module 42. The other levels represent the brightness values that are distributed between these extremes. In this embodiment, the threshold value for screen switching is level 5. Thus, if the brightness value is anywhere from level 1 to level 5 in step 902, then step 903 is performed. However, if the brightness value is anywhere from level 6 to level 10 in step 902, which is a brightness used for general backlight modules of LCDs, then step 904 is performed.

In step 903, the determining module 253 determines whether the e-Paper 3 is showing the image signals. If the e-Paper 3 is showing the image signals, then the determining module 253 instructs the control module 252 to continue using the e-Paper 3 to show the image signals in step 905, i.e., neither the screen nor the operating system needs to be switched. If the e-Paper is not showing the image signals, it is necessary to switch the screen and the operating system (i.e., the LCD 4 is switched to the e-Paper 3, and the first operating system is switched to the second operating system). Speaking in more detail, in step 906, the determining module 253 instructs the control module 252 to temporarily store the image signals presently being shown in the flash memory 27, activates the e-Paper 3, switches the first operating system to the second operating system, and causes the first operating system to enter a sleep mode to save power. When the second operating system is activated, the control module 252 reads the image signals from the flash memory 27 and sends the image signals to the e-Paper 3 for showing thereon in step 907. Meanwhile, part of the light emitted by the backlight module 42 can be directed to the e-Paper 3 via the light guide plate 5. Thus, under insufficient ambient light, the e-Paper 3 is still easy to read. The control module 252 inactivates the backlight module 42 for saving power It is to be noted that because the LCD 4 is a transparent LCD, the user can see the image signals shown on the e-Paper 3 via the LCD 4.

In step 904, the determining module 253 determines whether the LCD 4 is showing the image signals. If the LCD 4 is showing the image signals, the determining module 253 instructs the control module 252 to continue using the LCD 4 for showing in step 908, i.e., neither the screen nor the operating system needs to be switched. If the LCD 4 is not showing image signals, then it is necessary to switch both the screen and the operating system (i.e., the e-Paper 3 is switched to the LCD 4, and the second operating system is switched to the first operating system). Speaking in more detail, in step 909, the determining module 253 instructs the control module 252 to temporarily store the current image signals in the flash memory 27, activates the LCD 4, switches the second operating system to the first operating system, and causes the second operating system to enter a sleep mode or a shutdown mode (since it has a fast startup speed) to save power. When the first operating system is activated, the control module 252 reads the image signals from the flash memory 27 and sends the image signals to the LCD 4 for showing thereon in step 910. At the same time, the control module 252 inactivates the e-Paper 3 for saving power.

As is clear from the above, the backlight module 42 functions as a light source for the e-Paper 3 through the design of the light guide plate 5, such that the e-Paper 3 under insufficient ambient light can still be read, and the goal of saving power is realized. Furthermore, another advantage of the present invention is that the backlight module 42 can be used efficiently. In particular, when the brightness value of the backlight module 42 is between level 1 and level 5 (that is, below the required brightness level for general LCDs), the backlight module 42 can be used as the light source for the e-Paper 3 via the light guide plate 5. In contrast, the brightness of the prior art backlight module can be operated only between level 6 and level 10, which corresponds to the brightness level for an LCD. Therefore, the backlight module 42 of the present invention can be utilized efficiently so as to save power.

In addition, the electronic apparatus 1 further includes a light sensor 20. The light sensor 20 is used for sensing ambient light brightness, and then sends a second brightness adjustment signal to the brightness adjustment module 251 of the CPU 25 via the signal input unit 22, the south bridge chip 23, and the north bridge chip 24. The second brightness adjustment signal includes information of the ambient light brightness. According to the second brightness adjustment signal, the brightness adjustment module 251 establishes the brightness value of the backlight module 42. Next, according to the established brightness value, the control chip 28 controls the power source 29 to thereby vary a voltage provided to the backlight module 42 by the power source 29 so as to adjust the brightness of the backlight module 42. Therefore, the electronic apparatus 1 has two ways to adjust the brightness of the backlight module 42. It is to be noted that the light sensor 20 automatically adjusts the brightness of the backlight module 42, while the UI 21 passively adjusts the brightness of the backlight module 42. The brightness value is set initially by the brightness adjustment module 251. If the user is not satisfied with the automatic setting of the brightness value, he/she can manipulate the UI 21, such that the resulting first brightness adjustment signal is used to cause the brightness adjustment module 251 to set the brightness value.

It is to be noted that the electronic apparatus 1 may be installed with a third operating system that can control the e-Paper 3 and the LCD 4 at the same time. In this case, in steps 906 and 909, it is not necessary for the determining module 253 to perform switching of the operating systems, and only needs to switch screens.

In sum, the electronic apparatus 1 using the screen switching method of the present invention can perform screen Switching between the e-Paper 3 and the LCD 4 according to the established brightness value of the backlight module 42. Furthermore, the backlight module 42 can function as the light source for the LCD 4 and the e-Paper 3 via the light guide plate 5 according to different brightness levels to thereby achieve power saving.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A screen switching method for an electronic apparatus including an e-Paper and a display having a backlight module, the e-Paper and the display being used to show an image signal, said screen switching method comprising:
a) determining whether a brightness value at which the backlight module is set exceeds a threshold value;
b) controlling the display to show the image signal if the brightness value of the backlight module exceeds the threshold value; and
c) controlling the e-Paper to show the image signal if the brightness value of the backlight module does not exceed the threshold value.

2. The screen switching method as claimed in claim 1, wherein when the electronic apparatus shows the image signal using the e-Paper, and in step a), the brightness value exceeds the threshold value, said screen switching method further comprises between step a) and step b):
d) storing the image signal in a memory of the electronic apparatus;
wherein in step b), the image signal is read from the memory and transmitted to the display.

3. The screen switching method as claimed in claim 2, wherein in step b), the e-Paper is switched off when the display shows the image signal.

4. The screen switching method as claimed in claim 1, wherein when the electronic apparatus shows the image signal using the display, and in step a), the brightness value does not exceed the threshold value, said screen Switching method further comprises between step a) and step c):
e) storing the image signal in a memory of the electronic apparatus;
wherein in step b), the image signal is read from the memory and transmitted to the e-Paper.

5. The screen switching method as claimed in claim 4, wherein in step c), the display is switched off when the e-Paper shows the image signal.

6. The screen switching method as claimed in claim 1, wherein the brightness value is set by a UI (user interface) of the electronic apparatus.

7. The screen switching method as claimed in claim 1, wherein the brightness value is set by a light sensor of the electronic apparatus sensing ambient light brightness.

8. The screen switching method as claimed in claim 7, wherein the brightness value set via a UI of the electronic apparatus can override the setting by the light sensor.

9. The screen switching method as claimed in claim 1, wherein in step c), the backlight module can function as the light source for the e-Paper.

10. An electronic apparatus for showing an image signal, said electronic apparatus comprising:
an e-Paper;
a display including a display panel and a backlight module for providing a light source;
a brightness adjustment module for setting a brightness value of said backlight module;
a control module for selecting to send the image signal to either said display or said e-Paper; and
a determining module for determining whether the brightness value exceeds a threshold value, said determining module controlling said control module to send the image signal to said display for showing thereon if the brightness value exceeds the threshold value, said determining module controlling said control module to send the image signal to said e-Paper for showing thereon if the brightness value does not exceed the threshold value.

11. The electronic apparatus as claimed in claim 10, wherein said control module includes a memory for storing the image signal, when said electronic apparatus shows the image signal using said e-Paper and said determining module determines that the brightness value exceeds the threshold value, said determining module controls said control module to temporarily store the image signal in said memory, after which the image signal is read by said memory and sent to said display for showing thereon.

12. The electronic apparatus as claimed in claim 11, wherein said control module switches off said e-Paper.

13. The electronic apparatus as claimed in claim 10, wherein said control module further includes a memory for storing the image signal, when said electronic apparatus shows the image signal using said display and said determining module determines that the brightness value does not exceed the threshold value, said determining module controls said control module to temporarily store the image signal in said memory, after which the image signal is read by said memory and sent to said e-Paper for showing thereon.

14. The electronic apparatus as claimed in claim 13, wherein said control module switches off said display.

15. The electronic apparatus as claimed in claim 10, wherein said display is a transparent LCD, one surface of said display being connected to said e-Paper, and the other surface of said display facing a user.

16. The electronic apparatus as claimed in claim 15, wherein said backlight module is disposed on a side of said display panel, said electronic apparatus further comprising a light guide plate disposed between said e-Paper and said display, said light guide plate being used to direct light from said backlight module above said e-Paper.

17. The electronic apparatus as claimed in claim 10, further comprising a UI (user interface) connected to said brightness adjustment module, said brightness adjustment module being used for setting the brightness value in accordance with a first brightness adjustment signal from said UI.

18. The electronic apparatus as claimed in claim 10, further comprising a light sensor that is connected to said brightness adjustment module and is used for sensing ambient light brightness, said brightness adjustment module setting the brightness value in accordance with a second brightness adjustment signal from said light sensor, the second brightness adjustment signal including information of the ambient light brightness.
